(19) United States
(12) Patent Application Publication
(10) Pub. No.: US 2023/0094754 A1
(43) Pub. Date: Mar. 30, 2023

(54) Multifunctional Scrubbing Device

(71) Applicant: Elliot Hamilton, Jacksonville, FL (US)

(72) Inventor: Elliot Hamilton, Jacksonville, FL (US)

(21) Appl. No.: 17/935,204

(22) Filed: Sep. 26, 2022

Related U.S. Application Data
(60) Provisional application No. 63/249,270, filed on Sep. 28, 2021.

(51) Int. Cl. A47L 13/22; A47L 13/254; A47L 13/42; A47L 13/51; A46B 5/00; A46B 5/02; A46B 11/00

(52) U.S. Cl. CPC A47L 13/22; A47L 13/254; A47L 13/42; A47L 13/51; A46B 5/005; A46B 5/0058; A46B 5/02; A46B 11/0062; A46B 2200/3033; A46B 2200/304

(57) ABSTRACT

The present invention relates to a multifunctional scrubbing device for easily and comfortably scrubbing difficult to reach areas. The device includes an extensible handle having locking pins for retracting and extending the handle, a scrub head having scouring element or pad in the form of bristles or sponge and of different textures for scrubbing. The handle is pivotally coupled to the scrub head using a pivot lock to allow the handle to pivotally move relative to the scrub head. The handle has an ergonomic grip for easy handling and a ring hook for hanging the device on a wall-mounted hook when the device is not use. In one embodiment, the device has one or more cleaning solution storage reservoirs disposed in the scrub head for dispensing cleaning or other solutions on the scouring element or pad.

### CROSS-REFERENCE TO RELATED APPLICATION

The present application claims priority to, and the benefit of, U.S. Provisional Application No. 63/249,270, which was filed on Sep. 28, 2021, and is incorporated herein by reference in its entirety.

### FIELD OF THE INVENTION

The present invention relates generally to the field of cleaning devices. More specifically, the present invention relates to a novel scrubbing device and method for easily scrubbing bathrooms; tiled areas; around fixtures, such as bathtubs, toilets, sinks and showers, without requiring users to bend, stretch or crouch. The device features a telescoping or extensible handle and a scrub head with a replaceable scouring element. The handle is configured to be pivotally movable relative to the scrub head and can be held in a single hand for cleaning hard surfaces or difficult to reach areas from a comfortable position. Accordingly, the present disclosure makes specific reference thereto. Nonetheless, it is to be appreciated that aspects of the present invention are also equally applicable to other like applications, devices, and methods of manufacture.

### BACKGROUND

By way of background, personal hygiene has been one of the most reliable prophylactic measures in maintaining good health. Germs are virtually everywhere, and people try hard to remove germs, stains, and pathogens. By way of example, a typical bathroom, especially fixtures, such as a bathtub, shower, toilet, sink, bidet area, and tile, require regular cleaning and scrubbing to keep the bathroom area clean. Hard to reach areas are difficult to clean using conventional cleaning tools, sprays and other cleansers, and may cause discoloration and an accumulation of dirt, grime and germs.

Multiple cleaning tools of various sizes and different length of handles are used for cleaning a bathroom. Cleaning of plumbing fixtures, such as a bathtub is difficult and frustrating. A person needs to sit on their knees, bend and crouch for cleaning a bathtub and other fixtures. This is difficult for elderly people, people having a backache, and people with limited physical mobility. It is common for people to stretch their muscles or even suffer an injury while cleaning the bathtub and shower. People desire an improved cleaning device that allows people to comfortably clean bathtubs and showers as well as other plumbing fixtures and difficult to reach areas.

Even the most expensive and quality bathroom cleaning products do not allow people to easily stand and scrub bathtubs. Such products cannot remove serious rust stains, mold, and grimy residue, unless they are used in conjunction with a scouring, pad, sponge, or cleaning brush. Additionally, sitting on one's knees while scrubbing a bathtub or shower can be painful and exhausting as well. Conventional cleaning devices are required to be thrown away when the scouring material gets worn out and further, the direction and length of the handle may not be adjustable leading to people needing to use multiple cleaning tools.

Therefore, there exists a long-felt need in the art for a scrubbing device that allows people to use a tool from a comfortable position to scrub and clean hard to reach areas, such as around bathroom fixtures like a bathtub, toilet, or shower. There is also a long-felt need in the art for a multifunctional bathroom cleaning device that is designed to clean bathtubs, showers, and other fixtures with ease. Additionally, there is a long-felt need in the art for a cleaning device that does not require people to sit on their knees and hands and eliminates the need for continuous bending and crouching to clean bathtubs, showers, other fixtures, and hard surfaces such as kitchen backsplashes and tiles. Moreover, there is a long-felt need in the art for a scrubbing tool that can be easily used by elderly people, others with back pain or limited mobility for cleaning various portions of a bathroom and their home. Further, there is a long-felt need in the art for a scrubbing tool that efficiently and easily cleans around the bathtub, tiles, showers and other fixtures of a bathroom, in addition to other areas of a home. Furthermore, there is a long-felt need in the art for a cleaning device that has a replaceable scouring element or pad with a handle that can be adjusted in length and direction. Finally, there is a long-felt need in the art for a multifunctional bathroom scrubbing device that functions like a standard scrubber for easily cleaning the bath, shower and other areas of a home without significant or continuous bending and stretching.

The subject matter disclosed and claimed herein, in one embodiment thereof, comprises a scrubbing device. The device is designed to easily clean difficult to reach areas such as plumbing fixtures, like bathtubs and showers, without a user bending, stretching, or risking injury. The device further includes a retractable handle having a plurality of telescoping or extendable pins which are used for extending or retracting the length of the handle between two feet and four feet. The invention includes a generally rectangular scrub head having a scouring element or pad disposed on the bottom surface thereof and a pivot lock disposed on the top surface of the scrub head and configured for pivotally coupling the handle and the scrub head. The retractable handle is configured to pivotally move 180 degrees relative to the scrub head, such that the scrub head remains static and substantially horizontal, and the handle allows the scouring element or pad to scrub the area to be cleaned such as a bathtub or shower while the handle is held by a user in a single hand.

In this manner, the telescoping scrubbing device of the present invention accomplishes all of the foregoing objectives and provides users with a tool designed to clean difficult to reach areas such as, in and around fixtures such as bathtubs and showers with ease without bending, stretching or crouching. The telescoping handle and pivot lock allows the device to reach hard-to-reach areas and allows people to use the device from a comfortable position with a single arm.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a scrubbing or cleaning device. The tool further includes a telescoping or extensible handle having a plurality of telescoping pins for extending or retracting the length of the handle. A scrub head, having a scouring element or pad disposed on the bottom surface of the handle and a gripping portion, is provided on the opposite end of the handle. A pivot lock is disposed on top surface of the scrub head and configured for pivotally coupling the handle and the scrub head in one of a number of positions. The telescoping handle is configured to pivotally move relative to the scrub head such that the scrub head remains static and substantially horizontal, and the handle allows the scouring element or pad to scrub and clean the area or fixture such as a bathtub or shower while the handle is held by a user in a single hand.

In yet another embodiment, a multifunctional bathroom cleaning device is disclosed. The cleaning device includes a wide scrub head, a retractable handle having first and second ends, and the handle includes a plurality of locking points along the length of the handle. The locking points are configured to lock the handle at various lengths for adjusting the length of the handle. A pivot lock is disposed at about the middle point of the wide scrub head. The pivot lock is configured to pivotally lock the bottom end of the handle and the scrub head. A removably attached scouring element, pad or head is disposed around the periphery of the scrub or cleaning head for scrubbing and cleaning an area or around a fixture, such as a bathtub, shower, sink, toilet, or other hard surface area, such as backsplash and tiled space. An ergonomic grip is disposed on the top end of the handle and a cleaning solution storage or reservoir is disposed in the scrub head for selectively dispensing cleaning solution on the scouring or cleaning element or pad for effectively scrubbing and cleaning an area or fixture.

In yet another embodiment, the top end of the retractable handle has a hook ring for hanging the device on a wall-mounted hook.

In yet another embodiment, the retractable handle has a retracted length of about two feet and an extended length of about four feet.

In yet another embodiment, the scouring element, head, or pad is one of bristles, woven material, or sponge.

In yet another embodiment, the scrub head has a plurality of apertures coupled to the cleaning solution storage for dispensing the cleaning solution on the scouring element. The apertures are sized from about ⅛″ to ½″.

In yet another embodiment, the handle is configured to move 180 degrees relative to the scrub head using the pivot lock.

In yet another embodiment, a bathtub and shower scrubbing, and cleaning device is disclosed. The tool has a generally quadrate or rectangular scrub head. The scrub head has a pivot lock on the top surface thereof and a scouring or cleaning element, head or pad is disposed on the bottom surface of the head. A retractable, stainless steel or other rigid material handle, such as plastic, aluminum or carbon fiber composite handle, is coupled to the pivot lock and is configured to have a pivotal movement relative to the scrub or cleaning head. The handle has at least two locking pins for retracting and extending the handle in a length between two feet and four feet. A user is able to hold the handle in one hand for scrubbing and cleaning areas as well as round fixtures, such as the bathtub and/or shower without bending, stretching or crouching.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the cleaning and scrubbing device of the present invention in accordance with the disclosed architecture;

FIG. 1B is a perspective representation of one potential embodiment of the scrub head of the scrubbing device of the present invention in accordance with the disclosed architecture and shows different areas of cleaning surfaces provided by the scrub head;

FIG. 2 illustrates a close-up view showing the pivotal movement of the telescoping handle using the pivot lock in accordance with the disclosed architecture;

FIG. 3 illustrates a perspective view of the scrubbing or cleaning head of the multifunctional cleaning tool in accordance with the disclosed architecture;

FIG. 4 illustrates a perspective view of an individual using the multifunctional scrubbing and cleaning tool of the present invention in accordance with the disclosed architecture;

FIG. 5 illustrates a flow chart depicting an exemplary process of using the scrubbing device of various embodiments of the present invention for scrubbing a bathtub and shower in accordance with the disclosed architecture; and

FIG. 6 illustrates one potential embodiment of a kit containing the cleaning and scrubbing tool of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a scrubbing or cleaning device that allows people to use the tool from a comfortable position for scrubbing and cleaning difficult or hard to reach areas. There is also a long-felt need in the art for a multifunctional cleaning tool that is designed to clean difficult to reach areas and other fixtures, such as bathtubs and showers, with ease. Additionally, there is a long-felt need in the art for a cleaning and scrubbing device that does not require people to sit on their knees and hands and eliminates bending and crouching for cleaning difficult to reach areas such as bathtubs, showers, backsplashes, and tiled areas. Moreover, there is a long-felt need in the art for a scrubbing or cleaning device that can be easily used by elderly people, people with back pain or limited mobility for cleaning various portions of bathrooms, kitchens and other hard to reach areas. Further, there is a long-felt need in the art for a scrubbing device that efficiently and easily cleans the bathtub, tile, shower, backsplash and other areas of a home or office. Furthermore, there is a long-felt need in the art for a cleaning and scrubbing tool that has a replaceable scouring element or pad in which the handle can be adjusted in both length and direction. Finally, there is a long-felt need in the art for a multifunctional scrubbing and cleaning device that functions like a standard scrubber for easily cleaning areas such as a bath and shower and allows people to conduct the cleaning without bending and stretching.

The present invention, in one exemplary embodiment, is a multifunctional cleaning and scrubbing tool. The cleaning device includes a scrub head, a retractable handle, and the handle includes a plurality of locking pins disposed along the length of the handle. The handle has a first end and second end with a hand grip disposed on one end and a cleaning or scrubbing head disposed at the opposite end. The locking points are configured to lock the handle at various lengths for adjusting the length of the handle. A pivot lock is disposed at about middle point of the wide scrub head and the pivot lock is configured to pivotally lock the bottom end of the handle to the scrub head. A removably attached scouring and cleaning element is in the form of a sponge, woven material, or bristles disposed around the periphery of the scrub head for scrubbing and cleaning area such as a bathtub, shower, backsplash, and other tiled areas. An ergonomic grip is disposed on the top end of the handle and a cleaning solution storage reservoir is disposed in the scrub head for selectively dispensing cleaning solution on the scouring element or pad for effectively scrubbing. The head includes a number or plurality of apertures ranging from ⅛″ to ½″ for allowing the cleaning solution to be dispensed from the head.

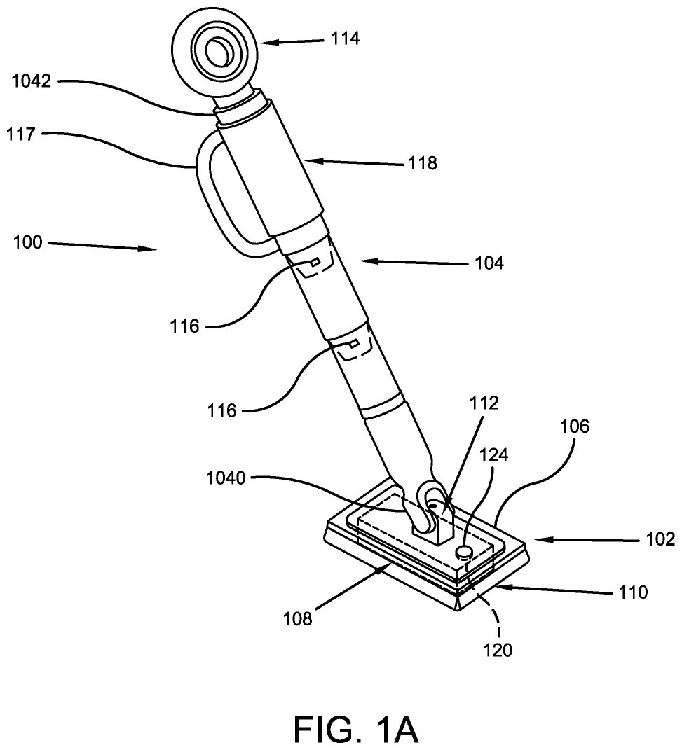

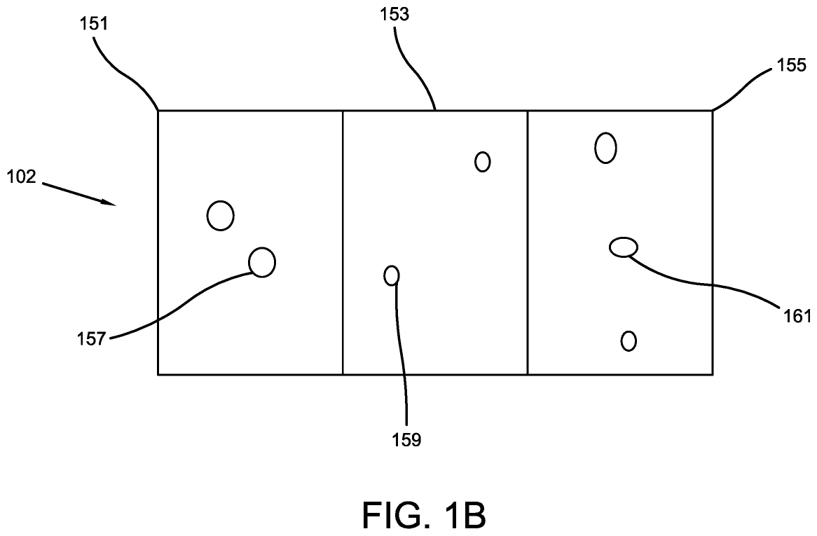

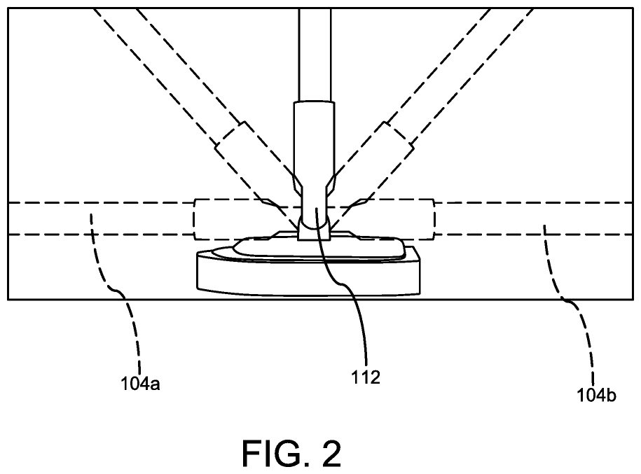

Referring initially to the drawings, FIG. 1A illustrates a perspective view of one potential embodiment of cleaning and scrubbing tool 100 of the present invention in accordance with the disclosed specification. The scrubbing and cleaning device 100 of the present invention is designed to clean difficult to reach area such as bathtubs, backsplashes and showers with ease without the need for continuous bending or getting on one's hands and knees. The scrub device or tool 100 allows people to clean the target area from a comfortable position with a single arm without any discomfort and stretching. More specifically, the scrubbing and cleaning device 100 includes a scrub head 102 that is pivotally coupled to a telescoping or extensible handle 104. The scrub device 100 has a top surface 106 and a bottom surface 108 with scouring elements 110 positioned on the bottom surface 108 of the head 102. A pivot lock 112 is positioned on the top surface 106 of the scrub head 102 for pivotally coupling the head 102 and the handle 104. The pivot lock 112 allows the handle 104 to pivotally move 180 degrees relative to the scrub head 102 as illustrated in FIG. 2 for providing adequate coverage and enabling users to clean hard to reach areas such as those around a bathtub and shower.

The telescoping handle 104 has a bottom end 1040 that is fastened to the pivot lock 112 and has a top end 1042 on which a hook ring 114 is disposed. The hook ring 114 is used for hanging the scrub device 100 on a wall-mounted hook for easy storage purposes. The telescoping handle 104 has a telescoping structure and is configured to extend or retract as per the requirements of the users. A plurality of telescoping pins 116 are positioned along the handle 104 that allows the handle 104 to extend or retract. In a retracting position, the handle 104 can have a length of about two feet. In a fully extensible position, the handle 104 can have a length of about four feet, thereby allowing a user to clean and scrub difficult to reach areas such as backsplashes, bathtubs and showers of all sizes without bending and stretching.

An ergonomic rubber grip 118 is removably attached near the top end 1042 of the handle 104 for easy handling of the scrub device 100 during use. The grip 118 can be smooth or can have ridges, as per preferences of users of the device 100. The grip area 118 may have a hand guard 117 in order to prevent the user's hand from hitting surfaces while cleaning or to provide a further grip for holding onto the handle. In the preferred embodiment, the scrub head 102 is substantially rectangular and can have dimensions of 12″ (L)×9″ (W)×1″ (H). The scouring element 110 may include any scouring element or pad such as, but not limited to, sponges, bristles, woven material and combinations thereof. If the scouring element or pad 110 is a sponge, it is contemplated that the sponge may be a single, larger sponge or a plurality of smaller sponges dispersed over the bottom surface 108 with each of the smaller sponges having differing degrees of hardness, such as soft, medium and hard, to allow a different force to be applied by each area of the cleaning head. If a scouring element or pad 110 consists of bristles, it is contemplated that the bristles may form a single bristled region, or a plurality of tufts of bristles dispersed over at least a portion of the bottom surface 108. As with the sponges, different type of bristles can be used in different areas of the cleaning head to provide additional cleaning as will be discussed in connection with FIG. 1B.

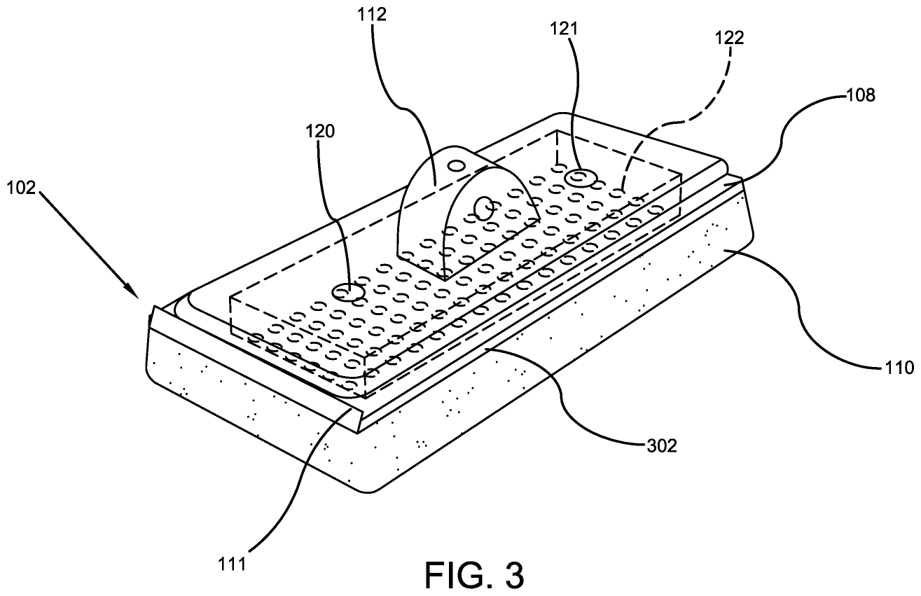

A cleaning solution storage portion 120 is disposed in the scrub head 102 and is accessible from the top surface 106 of the head 102. The storage portion 120 is coupled internally to a plurality of apertures 122 (as shown in FIG. 3) positioned on the bottom surface 108 of the head 102 for dispensing the stored cleaning solution. When a top lid 124 of the storage portion 120 is pressed by a user, the cleaning solution is released and dispensed from the apertures 122 and is used by the scouring or cleaning element or pad 110 for cleaning the desired area.

It should be noted that the preferred embodiment of the bathroom scrubbing or cleaning device 100 of the present invention is non-powered or non-motorized but a powered device 100 facilitating automated movement of the scouring element or pad 110 is also within the scope of the present invention.

The multifunctional bathroom and bathtub cleaning device 100 helps a user to reach the difficult to reach areas such as those places near the ceiling, bathtub floor, shower area and backsplash, with little effort on shoulders and back and without bending, stretching, or crouching. The head 102 may be removed from the pivot lock 112 and can be replaced with a new head when required. The cleaning device 100 is designed to be economical, portable, easy-to-use, fast-acting and effective in cleaning the bathroom and other areas of the home and minimizing stains and proliferation of bacteria and viruses.

FIG. 1B shows the undersurface of the head 102 and provides different cleaning surfaces depicted as 151, 153 and 155. These different areas can be different sponge types, bristle types or woven materials and may range in hardness from soft to hard. In addition, each of the particular areas are provided with apertures 157, 159 and 161 which may be of different sizes to allow different amounts of solutions to be dispensed into each type of head area. For example, a soft area of the head 155 may have more holes 161 as that portion of the head is used for polishing or final cleaning, whereas the harder portions of the head may have different sized holes or fewer holes as the user is relying more on the firmness or hardness of the cleaning head material rather than the cleaning solution to complete the scrubbing.

FIG. 2 illustrates a close-up view showing the pivotal movement of the telescoping or extensible handle 104 using the pivot lock 112 in accordance with the disclosed specification. The pivot lock 112 allows pivotal movement of the handle 104 relative to the device head 102 and therefore enables user to reach different areas of the space to be cleaned easily. As illustrated, the pivotal lock 112 is affixed to the top surface 106 of the head 102 and the handle 104 is attached through a hinge. The handle 104 is configured to rotate 180 degrees from the initial position shown as 104a to the final position 104b. The handle 104 is configured to achieve any position between the two extreme positions 104a, 104b and remains locked in the selected position allowing a user to perform cleaning operation of a target area easily and stably.

FIG. 3 illustrates a perspective view of the scrub and cleaning head 102 of the multifunctional cleaning and scrubbing device 100 in accordance with the disclosed specification. The bottom surface 108 of the head 102 has a plurality of apertures 122 for selectively dispensing cleaning solution onto the sponge/scouring element 110. The apertures 122 do not impinge on functionality and utility of the scouring element 110 and help in providing effective cleaning of bathtub, tile, shower areas and more. The apertures are sized from ⅛″ to ½″ and may vary in size so that there can be a larger amount of solution dispersed into the central area and lesser amounts dispensed into other areas of the head. The head 102 may also have an additional scrubbing bar 111 along one or more edges of the head so that the head can be used to scrap off tough stains or other grim. In addition, the head 102 may be provided with a second reservoir 121 so that the head can be used to dispense two different solutions for cleaning. For example, the user may wish to dispense a more abrasive solution first from the first reservoir 120 and then a polishing solution from the second reservoir 121. The scrubbing pad may be held to the head 102 by a removable adhesive, hook and loop fasteners, mechanical fasteners such as snaps as well as magnets. Alternatively, the pad may slide into a channel or groove 302 to hold the pad in position for scrubbing.

In the preferred embodiment, the head 102 has a channel 302 around the periphery for securing the scouring or cleaning element 110. The scouring or cleaning element 110 can be removed from the channel 302 and can be replaced with a new sponge 110 as required by a user. This increases the utility of the cleaning and scrubbing device 100 and helps in maintaining hygiene and cleanliness.

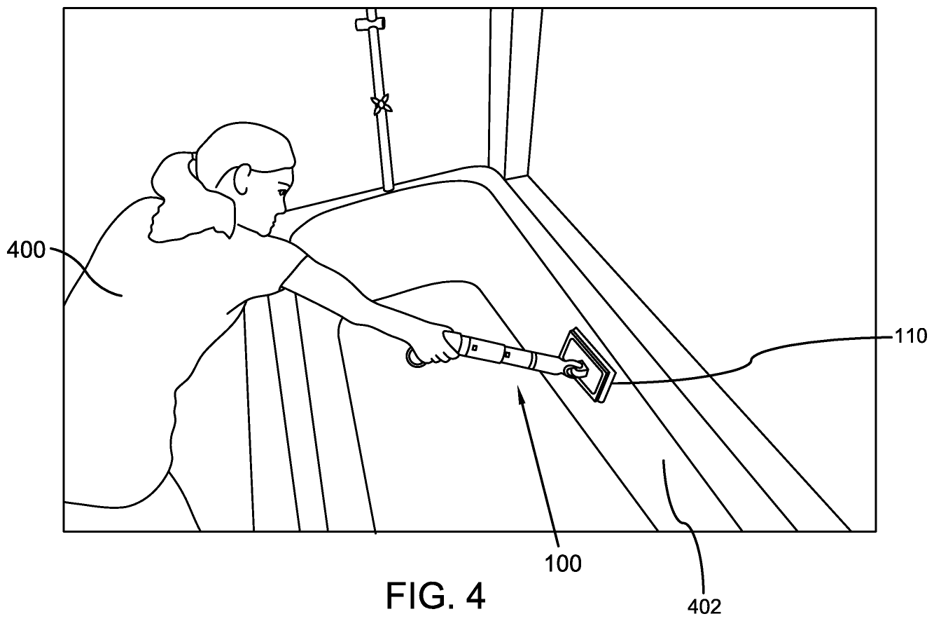

FIG. 4 illustrates a perspective view of a user using the multifunctional cleaning tool 100 of the present invention in accordance with the disclosed specification. The handle 104 of the device 100 has a length of up to four feet that enables the user 400 to reach a bathtub 402, floor tiles, bathroom tiles near the ceiling, and other difficult to reach areas by standing up and without bending, stretching, and crouching. Further, the device 100 is lightweight and can be used in a single hand operation, thereby allowing the user 400 to hold a support or use any other cleaning device in the other hand. Users having height ranging from about four feet to seven feet can clean various surfaces without stretching and bending. An extension can be provided to allow the user to further extend the handle. The scouring element 110 is used for scrubbing and cleaning the target surface without causing any scratches or decoloring the surface.

The handle 104 can be made from any rigid, lightweight, durable, inert, and non-conductive material such as, for example, polypropylene or polyvinyl chloride (PVC), stainless steel, aluminum, or wood. The shape and size of the device 100 can be scaled and adapted to accommodate the shape and size of different areas or fixtures to be cleaned such as bathtubs, showers and backsplashes, and can also be constructed to increase aesthetic appeal, to maintain the décor of the bathroom or any other area in which the device 100 is stored.

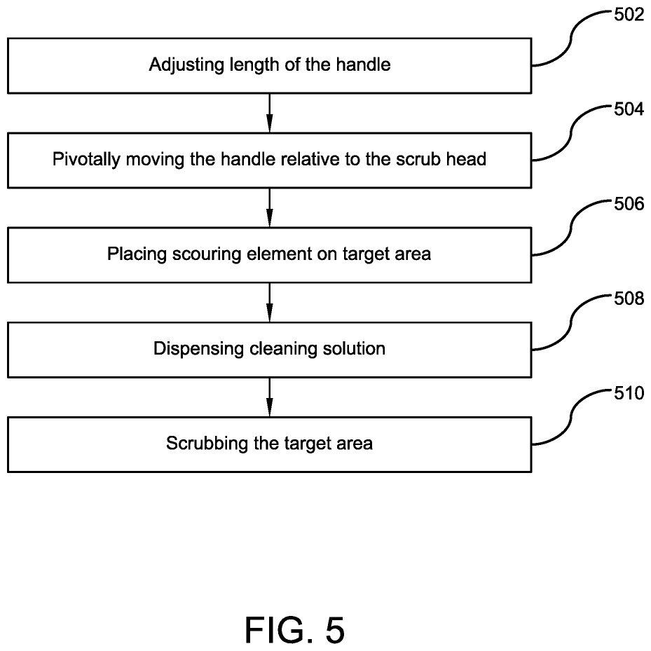

FIG. 5 illustrates a flow chart depicting an exemplary process of using the scrubbing device or tool of various embodiments of the present invention for scrubbing an area or fixture such as a bathtub and shower in accordance with the disclosed specification. Initially, based on the size of a target area (such as a surface of a bathtub or shower) and distance of a user from the target area, the length of the telescoping handle is adjusted (Step 502). Then, the handle is pivotally moved relative to the scrub head depending on the direction of the user (Step 504) and thereafter, the scouring element is placed on the target area (Step 506). The cleaning solution is dispensed by depressing one or more of the lids or buttons connected to a storage area or reservoirs disposed on the scrub head (Step 508). Finally, the target area is easily scrubbed without applying much force for a clean and stain free surface (Step 510).

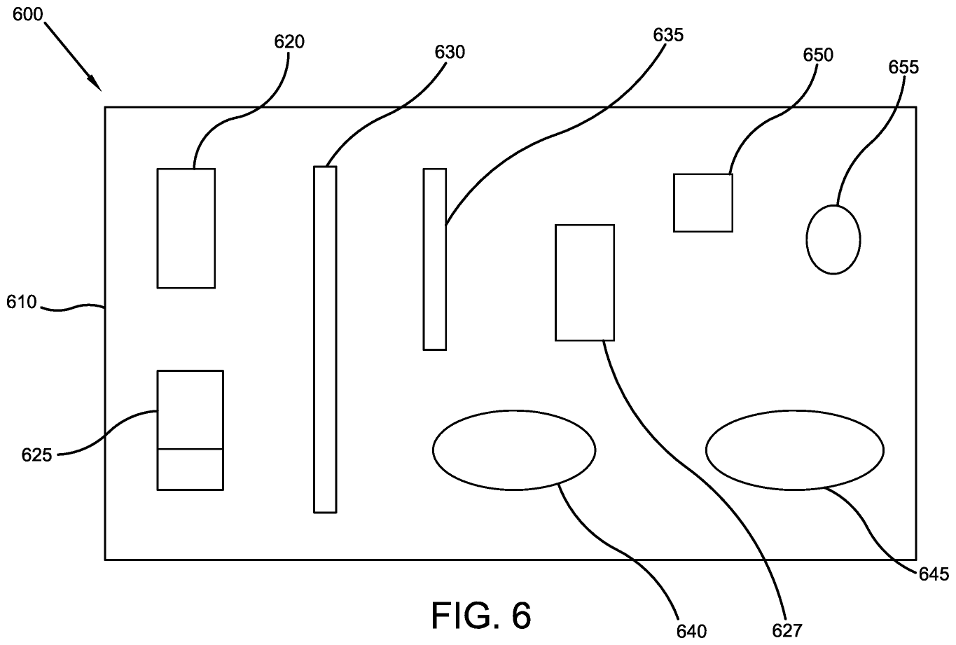

FIG. 6 provides a kit 600 for making the scrubbing or cleaning tool available to the user. The kit 600 includes a box or other container 610 suitable for retail sale or online distribution applications. Housed within the kit, are scrub heads 620 and 625, with 625 showing a head with different textures or hardness of the scrubbing material. The head 627 is provided to be attached to the handle and the scrubbing or cleaning heads. Also included in the kit 600 is a handle 630 and an extension 635 which allows the handle to be extended to a desired length from between two feet to seven feet in length. The kit 600 may also be provided with one or more supplies of cleaning material 640 and 645 which can be used to fill or refill one or more of the reservoirs contained within the cleaning heads. The kit 600 may also include one or more different textures or hardness of bristles, sponges or woven materials 650 and 655 so that the user can change the texture of the cleaning and scrubbing head depending on the cleaning to be performed.

Other shapes, designs, and configurations of the exemplary device 100 are contemplated and fall within the scope of the invention without affecting the utility of the device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multifunctional cleaning device”, “cleaning device”, “bathtub and shower scrub device”, “multifunctional bathroom and bathtub cleaning device”, and “scrub device” are interchangeable and refer to the multifunctional bathroom and bathtub cleaning device 100 of the present invention.

Notwithstanding the foregoing, the multifunctional bathroom and bathtub cleaning device 100 of the present invention can be of any suitable size and configuration as is known in the art without affecting the overall concept of the invention, provided that it accomplishes the above-stated objectives. One of ordinary skill in the art will appreciate that the multifunctional bathroom and bathtub cleaning device 100 as shown in the FIGS. are for illustrative purposes only, and that many other sizes and shapes of the multifunctional bathroom and bathtub cleaning device 100 are well within the scope of the present disclosure. Although the dimensions of the multifunctional bathroom and bathtub cleaning device 100 are important design parameters for user convenience, the multifunctional bathroom and bathtub cleaning device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning tool comprising:
a handle comprised of a first end, a second end, and a grip disposed at the second end
a cleaning head positioned on the first end opposite the grip, wherein the cleaning head is pivotable about the handle to change a degree of cleaning and comprises a plurality of apertures;
a scrubbing pad attached to the cleaning head;
a reservoir contained within the cleaning head;
a cleaning solution contained in the reservoir; and
a button on the cleaning head for releasing the cleaning solution contained in the reservoir through the plurality of apertures in the cleaning head.

2. The cleaning tool as recited in claim 1, wherein the plurality of apertures range in size from ⅛″ to ½″.

3. The cleaning tool as recited in claim 1, wherein the cleaning head comprises a second reservoir.

4. The cleaning tool as recited in claim 3, wherein the second reservoir contains a different solution than the reservoir.

5. The cleaning tool as recited in claim 1, wherein the cleaning head comprises a scrubbing bar provided along at least one edge of the cleaning head.

6. The cleaning tool as recited in claim 1, wherein the cleaning head is connected to the first end of the handle by a pivotable lock which holds the cleaning head in a desired position.

7. The cleaning tool as recited in claim 1, wherein the handle is extendable between 2 and 7 feet.

8. The cleaning tool as recited in claim 1, wherein the handle comprises an extension.

9. The cleaning tool as recited in claim 1, wherein the handle comprises a plurality of pins to maintain the handle in an extended position.

10. The cleaning tool as recited in claim 1, wherein the grip comprises a guard to aid a user in holding the handle and protect a hand of the user.

11. The cleaning tool as recited in claim 1, wherein the scrubbing pad is comprised of a plurality of different textures or hardness.

12. The cleaning tool as recited in claim 11, wherein the plurality of different textures or hardness comprise a soft, a medium and a hard texture.

13. The cleaning tool as recited in claim 1, wherein the second end comprises a hook.

14. An adjustable scrubbing device comprising:
an extensible handle comprising a plurality of pins to retain the extensible handle at a desired length;
a head attached to a first end of the extensible handle, wherein the head comprises a plurality of apertures for releasing a solution;
a reservoir contained within the head, wherein the reservoir houses the solution;
a grip attached to a second end of the extensible handle opposite the first end;
a scrubbing element removably attached to the head; and
a pivot head for pivoting the head relative to the handle.

15. The adjustable scrubbing device as recited in claim 14, wherein the scrubbing element is comprised with a plurality of different textures or hardness.

16. The adjustable scrubbing device as recited in claim 14 further comprising a second reservoir contained within the head and containing a different solution than the solution in the reservoir.

17. The adjustable scrubbing device as recited in claim 14, wherein the plurality of apertures range in size from ⅛″ to ½″.

18. The adjustable scrubbing device as recited in claim 14, wherein the grip comprises a guard.

19. A kit for a cleaning tool, the kit comprising:
a box or packaging;
a plurality of cleaning pads having varying textures and hardness;
a handle;
an extension handle;
a cleaning head comprising a reservoir for holding a cleaning solution and a plurality of apertures ranging in size from ⅛″ to ½″; and
a plurality of different cleaning solutions.

20. The kit as recited in claim 19, wherein the handle comprises a length of between 2 and 4 feet and a plurality of pins to hold the handle in a desired position.
